(19) United States
(12) Patent Application Publication
(10) Pub. No.: US 2006/0073421 A1
(43) Pub. Date: Apr. 6, 2006

(54) METHOD OF FORMING A LIGHT GUIDE PLATE INSERT MOLD

(76) Inventors: Irene Chen, Tao-Yuan Hsien (TW); Jyh-Huei Lay, Tao-Yuan Hsien (TW); Tien-Yu Chou, Tao-Yuan Hsien (TW); Yuan-Hung Wang, Tao-Yuan Hsien (TW); Chin-Chen Yang, Tao-Yuan Hsien (TW); Chuan-Lun Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,793

(22) Filed: Oct. 6, 2004

(51) Int. Cl. B29C 33/38

(52) U.S. Cl. 430/320; 430/321; 430/330

(57) ABSTRACT

A substrate is provided, and a surface treating process is performed on the surface of the substrate. Then, a plurality of photo resist patterns are formed on the substrate, and a flow process is performed so that each photo resist pattern has a microlens surface. Finally, a metal layer is formed on the photo resist patterns so that the bottom surface of the metal layer has a plurality of patterns complementary to the photo resist patterns.

### BACKGROUND OF INVENTION

1. Field of the Invention

The present invention relates to a method of forming a light guide plate insert mold, and more particularly, to a method which improves the adhesion between a substrate and photo resist patterns formed thereon or adjusts the surface energy of the substrate by performing a surface treating process.

2. Description of the Prior Art

A light guide plate (LGP) is an important element of an LCD. The light guide plate functions to reflect the light source generated by a back light module toward each pixel region so that the LCD can have a brilliant and equivalent brightness. In order to improve the light usage, the LGP normally includes a plurality of patterns on the surface to transform a point light source into a planar light source. The size or shape of the patterns, however, varies according to different optic designs and allocations of the fluorescent tubes.

Since the light guide plate is substantially composed of plastic materials, injection molding technology is generally adopted incorporating with an insert mold having patterns on the surface to form the LGP. Therefore, the quality of the patterns of the LGP is decided by the quality of the patterns of the insert mold. In addition, since the process of fabricating the insert mold is started by forming a plurality of photo resist patterns, the quality of the photo resist patterns is dominant to the quality of the patterns of the insert mold.

Please refer to FIG. 1 to FIG. 3, FIG. 1 to FIG. 3 are schematic diagrams illustrating a conventional method of forming an LGP insert mold. As shown in FIG. 1, at first a substrate 10 is provided, and a priming process is performed to coat a hexamethyidislazane (HMDS) layer 12 onto the substrate 10. HMDS is a dehydrant which is able to convert the surface condition of the substrate 10 from dydrophilic into lipophilic so as to improve the adhesion of the photo resist layer 14 to be coated. A photo resist layer 14 is then coated onto the HMDS layer 12. As shown in FIG. 2, an exposing and developing process is performed to remove a portion of the photo resist layer 14 to form a plurality of photo resist patterns 16.

Since each pattern of the LGP normally has a microlens surface for improving the light usage, a flow process is therefore required so that each photo resist pattern 16 has a smooth microlens surface. In the flow process, the temperature of the photo resist patterns 16 is raised over its glass transition temperature, and three kinds of tensions, which are tension between photo resist and atmosphere (γ_{P-A}), tension between photo resist and substrate (γ_{P-S}), and tension between substrate and atmosphere (γ_{S-A}), act on each photo resist pattern 16. When these three tensions reach an equivalent state, a photo resist pattern 16A with a microlens surface as shown in FIG. 3 is then formed.

It is noted that in the course of forming the photo resist patterns 16A it requires enough adhesion between the photo resist layer 14 and the substrate 10; otherwise the photo resist pattern 16 would collapse and the photo resist pattern 16A with a perfect microlens surface will not appear. In addition, in the flow process the photo resist pattern 16 can easily slide outward so as to form a photo resist pattern 16C instead of an expected photo resist pattern 16B (shown by the dotted line). The HMDS layer 12 might improve the adhesion between the photo resist patterns 16 and the substrate 10 to a certain extent, and is feasible in the case of forming ordinary photo resist patterns (such as photo resist patterns in the semiconductor processes). For the photo resist patterns 16 used in forming an LGP insert mold, however, it fails to form the correct photo resist patterns with the correct shape (e.g. 16A) due to insufficient adhesion.

As described, the dimensions of the photo resist patterns 16 change with different designs of the LGP. Therefore, in addition to the adhesion between the photo resist patterns 16 and the substrate 10, the surface energy of the substrate 10 is also required to be adjusted to a proper condition so as to ensure the photo resist pattern 16A with correct microlens shape are formed. For example, if the photo resist pattern 16A to be formed has a small radius of curvature, the surface energy of the substrate 10 must be adjusted so as form a large critical angle between the photo resist pattern 16A and the substrate 10. The conventional method fails to fulfill this requirement, and therefore suffers from the collapse or formation of the photo resist pattern 16C with a wrong shape.

In view of this shortcoming, how to improve the adhesion between the photo resist layer and the substrate and adjust the surface energy of the substrate so as to ensure the quality of the photo resist patterns in the flow process is a key topic to study.

### SUMMARY OF INVENTION

It is therefore a primary objective of the present invention to provide a method of forming an LGP insert mold for resolving the aforementioned problem.

According to the claimed invention, a method of forming an LGP insert mold is provided. The method includes the following steps. First, a substrate is provided, and a surface treating process is performed. Following that, a plurality of photo resist patterns is formed on the substrate, and a flow process is performed so as to form a microlens surface on each photo resist pattern. Then, a metal layer is formed on the photo resist patterns so as to form a plurality of patterns complementary to the photo resist patterns on a bottom surface of the metal layer.

Since the method of forming the LGP insert mold according to the present invention includes a surface treating process, the adhesion between the photo resist layer and the substrate is effectively improved. In addition, the surface energy of the substrate is adjusted during the surface treating process so that photo resist patterns with different shapes can be easily implemented.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 to FIG. 3 are schematic diagrams illustrating a conventional method of forming an LGP insert mold.

FIG. 4 is a flow chart illustrating the method of forming an LGP insert mold according to the present invention.

FIG. 5 to FIG. 7 are schematic diagrams illustrating the method of forming the LGP insert mold according to a first preferred embodiment of the present invention.

FIG. 8 is a schematic diagram illustrating the method of forming the LGP insert mold according to a second preferred embodiment of the present invention.

FIG. 9 is a schematic diagram illustrating the method of forming the LGP insert mold according to a third preferred embodiment of the present invention.

FIG. 10 is a schematic diagram illustrating the method of forming the LGP insert mold according to a fourth preferred embodiment of the present invention.

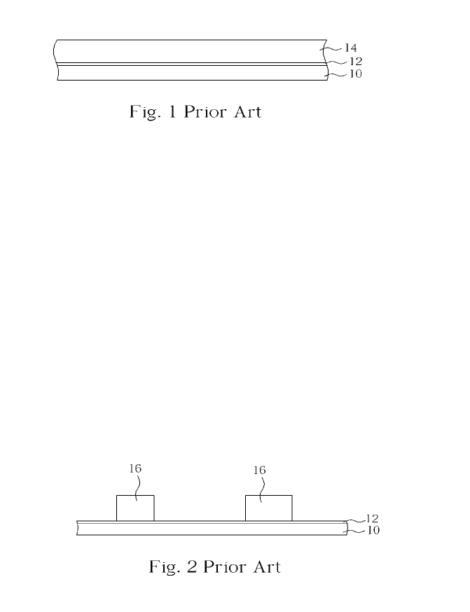

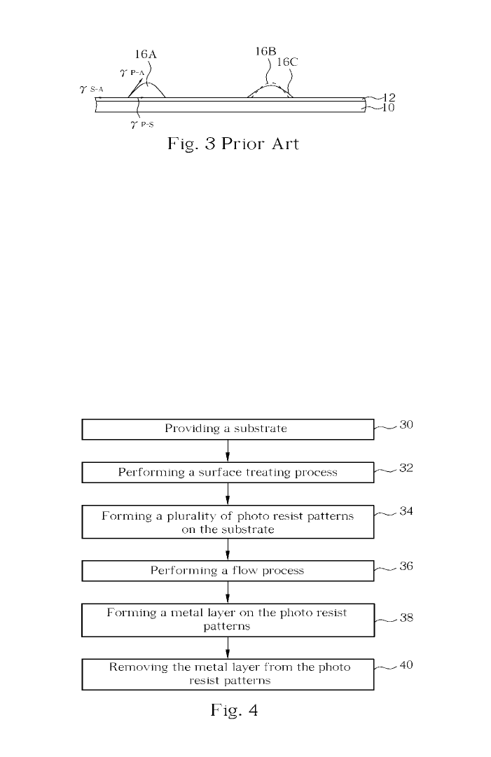

### DETAILED DESCRIPTION

Please refer to FIG. 4, which is a flow chart illustrating the method of forming an LGP insert mold according to the present invention. As shown in FIG. 4, the method of forming the LGP insert mold includes the following steps:

Step 30: providing a substrate;

Step 32: performing a surface treating process;

Step 34: forming a plurality of photo resist patterns on the substrate;

Step 36: performing a flow process so that each photo resist pattern has a microlens surface;

Step 38: forming a metal layer on the photo resist patterns so that the bottom surface of the metal layer has a plurality of patterns complementary to the photo resist patterns; and

Step 40: departing the metal layer from the photo resist patterns and the substrate.

It can be seen that the method of forming the LGP insert mold according to the present invention is characterized by performing a surface treating process before forming the photo resist patterns. The surface treating process is performed for increasing the adhesion between the photo resist patterns and the substrate so that the photo resist patterns tightly stick to the substrate during the flow process. In addition, the surface treating process can be controlled to adjust the surface energy of the entire substrate or the surface energy of a certain area. The surface treating process includes a thin film deposition process, a roughening process, a photo resist film coating process, or a surface activating process, etc. In practice, at least one of the aforementioned processes can be adopted to increase the adhesion between the photo resist patterns and the substrate, adjust the surface energy of the substrate, or implement both. For further illustrating the present invention, different embodiments are described as follows.

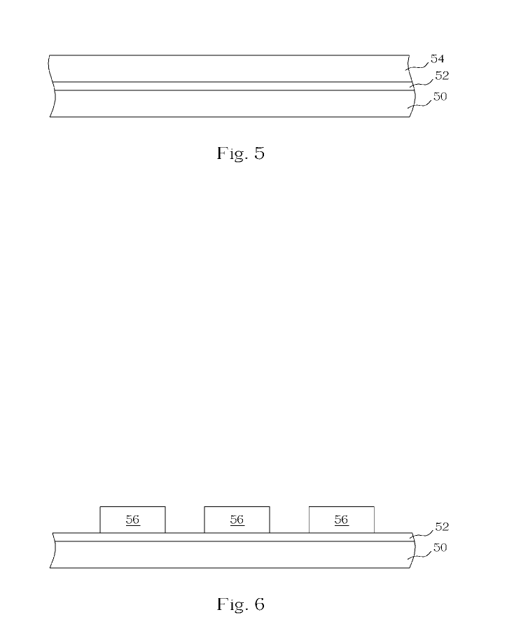

Please refer to FIG. 5 to FIG. 7, which are schematic diagrams illustrating the method of forming the LGP insert mold according to a first preferred embodiment of the present invention, where in this preferred embodiment the thin film deposition technology is adopted. As shown in FIG. 5, a substrate 50 such as a glass substrate, a silicon substrate, or a metal substrate is provided. Then a rinsing process is performed for rinsing the substrate 50 with water or other solvents for cleaning, and a dehydrating process follows to remove the water or solvents remaining on the substrate 50. Following that, a silver thin film 52 is formed onto the substrate for enhancing adhesion with the photo resist layer to be coated. It is noted that silver thin film 52 is only an example, any other metal thin films able to tightly adhere to the photo resist layer to be coated can be adopted. In addition, the silver thin film 52 can be formed by various deposition technologies, such as physical vapor deposition, chemical vapor deposition, electroplating, electroless plating, etc. Then a photo resist layer 54 is coated on the silver thin film 52.

As shown in FIG. 6, a photo mask (not shown) is utilized to perform an exposing and developing process so as to form a plurality of photo resist patterns 56. The light source (such as UV light or IR light), the exposing method, and the developing conditions of the exposing and developing process are chosen so as to form desired photo resist patterns 56. Furthermore, other necessary processes, such as a soft bake process or a hard bake process, can be incorporated.

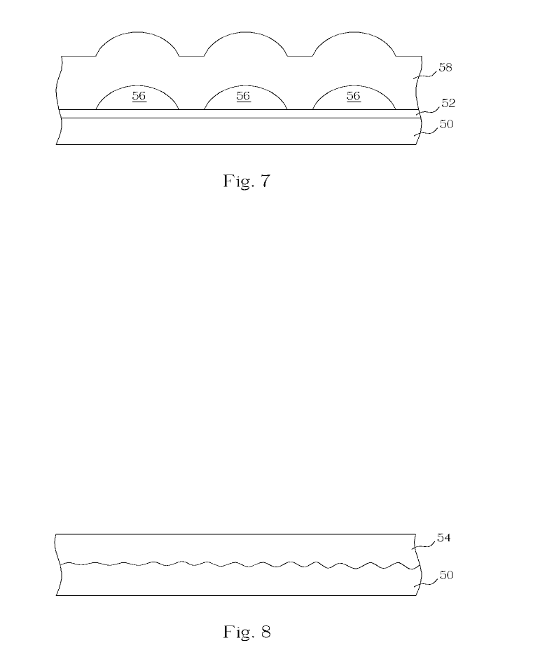

As shown in FIG. 7, a flow process is performed so that each photo pattern 56 has a microlens surface. The theorem of the flow process has been explained earlier and is not redundantly described here. Since the adhesion between the silver thin film 52 and the photo resist patterns 56 is superior to that between the substrate 50 and the photo resist patterns 56, the photo resist patterns 56 will not collapse or slide outward. A metal layer 58 is then formed on the photo resist patterns 56 and the silver thin film 52 by electroplating so that the bottom surface of the metal layer 58 has a plurality of patterns complementary to the photo resist patterns 56. Finally, the metal layer 58 is departed from the photo resist patterns 56 and the silver thin film 52. The metal layer 58 can be an LGP insert mold as long as the top surface is planarized.

Since the characteristic of the present invention involves utilizing different surface treating processes to improve the adhesion of the photo resist patterns or adjust the surface energy of the substrate, the following embodiments focus on different surface treating processes. Please refer to FIG. 8, which is a schematic diagram illustrating the method of forming the LGP insert mold according to a second preferred embodiment of the present invention, where in this preferred embodiment a roughening process is adopted. As shown in FIG. 8, a substrate 50 is provided. Then a rinsing process is performed for rinsing the substrate 50, and a dehydrating process follows. Following that, a roughening process is performed so that the substrate 50 has a rough surface. The roughening process can be implemented by physical methods, such as blasting treatment, or chemical methods, such as etching treatment. And the roughness or the rough design can be decided by practical effects or by different roughening processes. A photo resist layer 54 is then coated on the substrate 50. Compared to a smooth surface, the rough surface ensures a better adhesion between the photo resist layer 54 and the substrate 50.

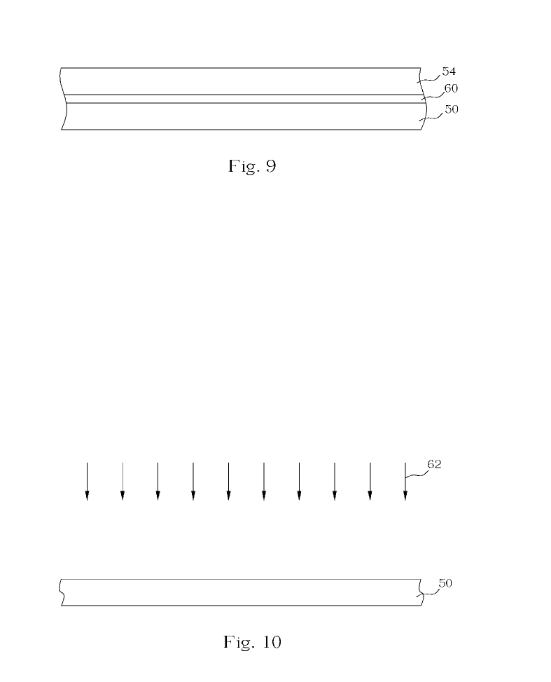

Please refer to FIG. 9, which is a schematic diagram illustrating the method of forming the LGP insert mold according to a third preferred embodiment of the present invention, where in this preferred embodiment two photo resist layers are coated. As shown in FIG. 9, a substrate 50 is provided. Then a rinsing process is performed for rinsing the substrate 50, and a dehydrating process follows. Following that, a photo resist thin film 60 is coated onto the substrate 50, and a hard bake process is performed to reduce the solvent contained in the photo resist thin film 60. The photo resist thin film 60 has a thickness of 1 μm or less, and aims to improve the adhesion of the substrate 50. In addition, the photo resist thin film 60 and the photo resist layer 54 to be coated are homogeneous and have a smaller critical angle, thus this preferred embodiment is suitable for forming the photo resist patterns having a flat shape (larger radius of curvature). It is noted that the photo resist thin film 60 is not used to define the photo resist patterns, and thus a hard bake process is directly performed without performing a soft bake process beforehand. Then, a photo resist layer 54 is coated onto the photo resist thin film 60, and a soft bake process is performed.

Please refer to FIG. 10, which is a schematic diagram illustrating the method of forming the LGP insert mold according to a fourth preferred embodiment of the present invention, where in this preferred embodiment a surface activating process is adopted. As shown in FIG. 10, a substrate 50 is provided. Then a rinsing process is performed for rinsing the substrate 50, and a dehydrating process follows. Following that, plasma 62 is utilized to bomb the surface of the substrate 50 so as to alter the surface energy of the substrate 50. It is noted that utilizing the plasma 62 to alter the surface energy of the substrate 50 is only an example, other methods, such as utilizing surfactant to rinse the substrate 50, can also be employed to adjust the surface energy of the substrate 50. By altering the surface energy of the substrate 50, the critical angle of the photo resist patterns to be formed can be controlled. Consequently, the photo resist patterns having different shapes can be formed.

It is worth noting that the method of the present invention can be acted on the entire substrate, and to a certain area of the substrate where necessary. For example, if the photo resist patterns having different shapes are required, the method can be selectively acted on a desired area of the substrate. In addition, different embodiments of the present invention can be incorporated where necessary to ensure that the substrate has optimal adhesion and surface energy. Furthermore, the HMDS can also be coated on the substrate before the surface treating process is performed for further improving the adhesion of the photo resist patterns.

In comparison with the prior art, the method of forming the LGP insert mold of the present invention alters the surface condition of the substrate by performing at least a surface treating process. Consequently, the adhesion between the substrate and the photo resist patterns to be formed is improved. This prevents the photo resist patterns from collapsing or sliding outward, and therefore the LGP insert mold with excellent quality can be formed.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of forming a light guide plate insert mold, comprising:
providing a substrate;
performing a surface treating process upon the substrate;
forming a plurality of photo resist patterns on the substrate; performing a flow process so as to form a microlens surface on each photo resist pattern; and
forming a metal layer on the photo resist patterns so as to form a plurality of patterns complementary to the photo resist patterns on a bottom surface of the metal layer.

2. The method of claim 1, wherein before the surface treating process is performed the method further comprises:
performing a rinsing process; and
performing a dehydrating process.

3. The method of claim 1, wherein the surface treating process is a thin film deposition process for forming a metal thin film on the substrate.

4. The method of claim 3, wherein the thin film deposition process is selected from technologies consisting of physical vapor deposition, chemical vapor deposition, electroplating, and electroless plating.

5. The method of claim 1, wherein the surface treating process is a roughening process for altering the roughness of the substrate.

6. The method of claim 5, wherein the roughening process is selected from technologies consisting of blasting treatment and etching treatment.

7. The method of claim 1, wherein the surface treating process is a surface activating process for altering the surface energy of the substrate.

8. The method of claim 7, wherein the surface activating process is selected from technologies consisting of plasma bombing and surfactant treatment.

9. The method of claim 1, wherein the surface treating process is a coating process for forming a photo resist film on the substrate.

10. The method of claim 1, wherein the step of forming the photo resist patterns further comprises:
coating a photo resist layer onto the substrate; and
performing an exposing and developing process to remove a portion of the photo resist layer.

11. The method of claim 1, wherein the surface treating process acts upon the entire substrate.

12. The method of claim 1, wherein the surface treating process partially acts upon the substrate.

13. The method of claim 1, wherein the metal layer is formed by electroplating.

14. The method of claim 1, wherein after the metal layer is formed the method further comprises a step of departing the metal layer from the substrate and the photo resist patterns so as to form the light guide plate insert mold.
